(19) United States
(12) Patent Application Publication
(10) Pub. No.: US 2019/0166853 A1
(43) Pub. Date: Jun. 6, 2019

(54) SYSTEMS AND METHODS FOR PIZZA PREPARATION

(71) Applicant: Todd T. Zahler, Columbus, OH (US)

(72) Inventor: Todd T. Zahler, Columbus, OH (US)

(21) Appl. No.: 16/209,808

(22) Filed: Dec. 4, 2018

Related U.S. Application Data
(60) Provisional application No. 62/594,192, filed on Dec. 4, 2017.

(51) Int. Cl. A21D 13/41; A21D 15/02

(52) U.S. Cl. CPC A21D 13/41; A23V 2300/38; A23V 2300/20; A21D 15/02

(57) ABSTRACT

Methods and systems for pre-prepared pizza sheets including cheese, toppings, and spices. Cheese, toppings, and spices are melted together to create a composite. As an alternative, water is applied and ingredients are frozen together. Amounts of ingredients may be predetermined to ensure consistency. The pizza sheets are frozen or refrigerated until they are placed on prepared dough and baked. Pizza sheets may be prepared and shipped on transport trays or plastic sheets which can be vertically stacked.

### CROSS-REFERENCE TO RELATED APPLICATIONS

This application is a non-provisional application which claims priority to U.S. Provisional Application No. 62/594,192, which was filed on Dec. 4, 2017. The contents of U.S. Provisional Application No. 62/594,192 are incorporated by reference as if fully reproduced herein.

### TECHNICAL FIELD

Exemplary embodiments of the present invention relate generally to food preparation systems and methods, and more specifically those used for making pre-prepared pizza sheets.

### BACKGROUND OF THE INVENTION

Pizza preparation is often a time-consuming job. Placing desired toppings on pizza takes time, and some restaurants have hundreds of pizza orders to fill each day. Customers often expect toppings to be placed in a uniform manner, and at the same time pizza makers must try to stay within their own rules for the amount of toppings to be placed on each pizza. For example, a certain number of ounces of cheese may be required to cover a pizza. When there is a high demand for pizza it can be hard for a pizza preparer to not only make the pizzas fast enough, but to make sure that they are adhering to business rules regarding the weight and/or appearance of toppings. As pizza oven technology increases it is often the pizza preparation station that becomes the slowest part of the pizza making process. Inefficient or rushed pizza preparation often costs more money in labor and results in higher foot cost waste. It may also cause the finished product to be of poor quality and impact customer satisfaction.

It is therefore an objective of the instant invention to provide for a more economical and efficient way to prepare pizza.

### SUMMARY OF THE INVENTION

Exemplary embodiments include methods of preparing frozen pizza sheets comprising cheese and toppings which may be placed onto dough and sauce prior to the cooking of the pizza. The pizza sheets may be prepared by placing a desired amount of cheese and any toppings, as well as any spices, onto a transport tray or other means for holding the ingredients. The cheese, toppings, and spices are heated so that the cheese melts around the other items and binds the ingredients together. The pizza sheet is cooled off, and may be frozen or refrigerated. The pizza sheet is packaged, and in some embodiments, may be packaged in multiples such as a stack of pizza sheets. At the time of use, the pizza sheet is removed from the packaging and transport tray, and placed on the prepared dough. The prepared dough may include sauce. The pizza sheet and dough are heated to create a cooked pizza for eventual consumption.

### BRIEF DESCRIPTION OF THE DRAWINGS

Novel features and advantages of the present invention, in addition to those mentioned above, will become apparent to those skilled in the art from a reading of the following detailed description in conjunction with the accompanying drawings in which:

FIG. 1 is a flow chart illustrating an exemplary embodiment of a method for creating and using a pizza sheet;

FIG. 2 is a perspective view of an exemplary pizza sheet;

FIG. 3 is a side view of an exemplary pizza sheet with transport tray and wax sheet;

FIG. 4 is an exemplary embodiment of multiple pizza sheets according to FIG. 3 in a stacked formation; and

FIG. 5 is an exemplary embodiment of multiple pizza sheets of an exemplary embodiment in a stacked formation.

### DETAILED DESCRIPTION

The present invention relates to systems and methods for preparing novel frozen or refrigerated pre-prepared pizza “sheets” that can be placed onto pizza dough and baked in an oven.

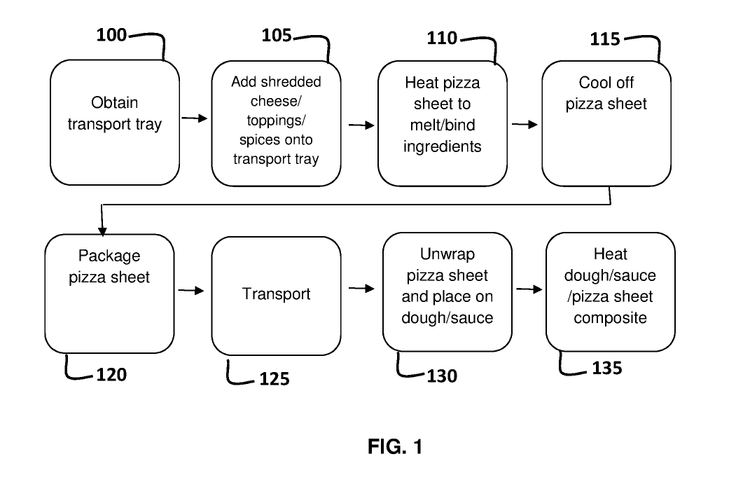

With reference to FIG. 1, in order to begin the process of creating a novel pizza sheet, the first step may be to acquire a transport tray for holding the finished pizza sheet 100. The transport tray may be cardboard, plastic, or another material. The material is ideally one that can withstand both heating and cooling during the pizza sheet manufacturing process. It may also be any shape and thickness desired as long as it can hold the pizza sheet. Depending on the shape of the intended finished pizza, the pizza tray may be shaped accordingly. For example, a circular transport tray may be used to hole a circular pizza sheet for an eventual circular pizza. Preferably, the transport tray is made from a material that allows for the frozen topping sheet to be easily peeled off for use. In some embodiments the transport tray may be treated with a non-stick spray. In other embodiments a wax paper sheet or other sheet may be placed between the transport try and the pizza sheet in order to assist with ease of removal of the sheet. The transport tray may be shaped appropriately that it can travel down an assembly line. The transport tray may have a corresponding transport top that can be snapped on once the pizza sheet is finished to protect the sheet during transport. The transport tray may also be designed such that multiple transport trays with pizza sheets can be stacked on top of one another for compact packaging. In a stacking arrangement, additional materials may be placed between the transport trays to aid in stability of the stack. For example, cardboard or plastic separators may be placed at desired intervals between the transport trays to aid in stability of the overall stack.

Next, the pizza “sheet” is prepared 105. In an exemplary embodiment, shredded cheese will be the first item applied to the topping sheet, although in other embodiments this may vary. The weight and/or volume of the shredded cheese to be used may be predetermined by the preferences of a customer. One of ordinary skill in the art will appreciate that there is commercially-available equipment that can shred and deposit cheese by pre-determined units of weight to ensure consistency. The shredded cheese is placed onto the transport tray and/or any sheet on top of the transport tray depending on the embodiment. It will be appreciated by one of ordinary skill in the art that if the desired pizza is a margherita pizza or other specialty pizza the cheese may not be shredded but instead sliced and/or crumbled. One of ordinary skill in the art will recognize that various forms of cheese, combinations of cheese, and layout of cheese may be used based on the type of pizza desired as the end result.

Desired toppings are then deposited on top of the cheese. One of ordinary skill in the art will recognize that there are commercially available topping applicators that can be used to slice, chop, and otherwise apply various types of toppings. A desired weight or volume of toppings can also be adhered to, ensuring uniformity across multiple pizza sheets. Examples of common toppings include pepperoni, sausage, peppers, and onions. Of course, any pizza topping and/or combination of pizza toppings desired could be added to the shredded cheese.

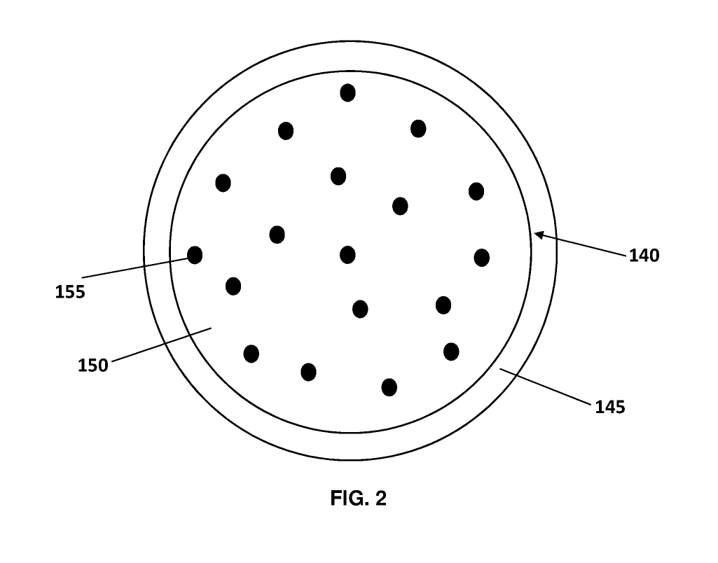

In some exemplary embodiments, any and all desired spices may be added to the pizza sheet once the toppings have been applied. Examples include, but are not limited to, ground pepper, garlic, red pepper flakes, and oregano. An example of a prepared pizza sheet 120 is shown in FIG. 2, wherein toppings 155 such as pepperoni and cheese 150 is placed onto a tray 145. It is also possible that olive oil, grated parmesan, or other items may be placed on top of the pizza sheet during this step as desired.

Once all items have been added to the pizza sheet, the sheet is heated in order to induce melting of the cheese and infusion of the toppings and/or any spices into the cheese 110. In an exemplary embodiment the pizza sheet may be heated for as long as desired at temperatures in a range of 225 to 450 degrees Fahrenheit in an assembly line oven. In an exemplary embodiment the temperature range may be around 325 to 350 degrees Fahrenheit, although in other embodiments the exact temperatures may vary, in part depending on the time it takes the pizza sheets to move through the oven. By heating the contents on the pizza sheet, the cheese melts to a degree and binds together with the toppings, spices, etc.

After the pizza toppings have been melted, the pizza sheets are put into a chilling tunnel to cool them down before packaging 115. Cooling the pizza sheets locks in the cheese, toppings, and/or any spices into a stable form. In an exemplary embodiment the pizza sheets are cooled in a temperature range of 32-35 degrees Fahrenheit, although in other exemplary embodiments cooling temperatures may vary. The desired cooling temperature may vary depending on whether the pizza sheets are intended to be transported in a frozen state or a refrigerated state. For those pizza sheets intended to be transported in a refrigerated state the cooling temperatures may be higher than for pizza sheets to be transported in a frozen state. It may only take a matter of minutes for the pizza sheets to cool. One of ordinary skill in the art will recognize that cooling can also be achieved by placing the pizza sheets in a refrigerator or other cooling device.

After the desired cooling has been achieved, the pizza sheets are packaged 120. If pizza sheets are to be packaged individually then each transport tray may separately be wrapped in shrink wrap or other packaging to preserve moisture and freshness. If pizza sheets are to be stacked, then the stack is first prepared and then the entire stack is shrink-wrapped.

An exemplary embodiment of a pizza sheet 140 on a circular transport tray 145 is shown in FIG. 2. As shown in FIG. 2, cheese 150 and toppings 155 are placed into a desired configuration on the tray 145.

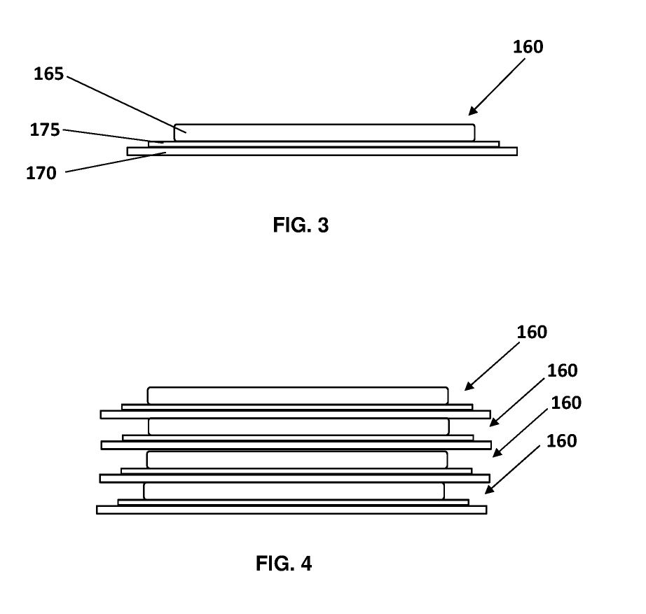

In FIG. 3, an exemplary embodiment of a pizza sheet composite assembly 160 is shown, wherein the composite 165 is placed on a transport tray 170 with a wax sheet 175 placed in-between to allow the pizza sheet composite 165 to be easily removed from the transport tray 170 when desired.

An exemplary embodiment of a stack of pizza composite assemblies 160 of the embodiment of FIG. 3 is illustrated in FIG. 4. In this embodiment, each pizza composite assembly 160 is stacked in vertical fashion on top of another pizza composite (with wax sheets, and transport trays included). The stacked formation may be wrapped to prevent moisture loss, preserve freshness, and otherwise preserve food safety during transport. Any necessary bar codes, and/or instructions on how to heat the pizza sheets may be included with the packaging. Ideally the packaged trays are transported in cooling trucks kept at temperatures in the range of 32-38 degrees Fahrenheit, although in various embodiments this may vary depending on whether the sheets are transported in a frozen or refrigerated state. One of ordinary skill in the art will recognize that there are various ways in which the pizza sheets can be packaged individually or as multiples.

Once packaged, the pizza sheet is ready for transport 125 to an end user. Ideally the pizza sheet is transported in a freezer or refrigerated atmosphere, such as a refrigerated truck, so that the pizza sheet maintains the desired temperature and does not spoil.

In an alternative exemplary embodiment, the pizza sheet composite may be formed by dropping cheese down onto a tray, and then spraying water over the top surface of the cheese. Toppings may then be applied. The composite is either frozen in a freezer or can be frozen through a chilling tunnel. During freezing, the water applied to the top surface of the cheese creates a bond between the cheese and the toppings, holding the ingredients together. In some exemplary embodiments the composite may not be frozen but only refrigerated until such time as it used.

When a pizza sheet is desired to be used, the user removes any packaging, separates the pizza sheet from the transport tray and/or any sheets, and places the pizza sheet on a prepared pizza dough and any desired sauce 130. The composite can then be heated, at which time the pizza sheet will re-melt and result in a pizza that is fresh-tasting and looks the same as a pizza prepared entirely from scratch (no pre-prepared pizza sheet) 135. The use of prepared pizza sheets as disclosed herein saves time for the pizza preparer as they do not have to spend time placing toppings on the pizzas. They also do not have to worry about achieving any required weights or volumes for toppings, as the pizza sheets can be prepared with uniformity. The pizza sheets can also reduce the amount of ingredients that a pizza preparer needs to have on hand, which can not only result in cost savings but also address concerns about food safety and reduce the amount of temperature monitoring that needs to take place.

Although in the exemplary embodiments above the pizza sheet does not include sauce, in other embodiments pre-prepared sauce sheets may also be created. Traditional pizza sauce may be mixed with gelatin in order to make the sauce hard and stable when cooled into a sheet. Other ingredients could also be used to help make a sauce sheet. A pre-prepared sauce sheet could be used in connection with the pre-prepared pizza sheets disclosed herein. In such a scenario, the end user only needs to have dough prepared, can then place a sauce sheet on the dough and then place a pizza sheet on top. This would also cut down on time and inconsistency.

In some exemplary embodiments, the pizza sheet may only contain cheese. In such an embodiment a user may use the cheese sheet to make cheese pizzas, or as a base for adding fresh toppings and/or spices prior to cooking the sheet in the oven. In other exemplary embodiments, the pizza sheet may only contain cheese and pepperoni, recognizing that pepperoni pizza is one of the more time-consuming pizzas to craft by hand, and yet also one of the most popular.

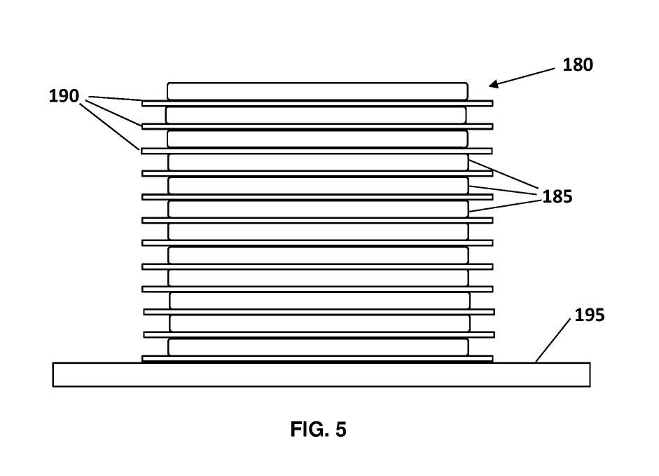

In exemplary embodiments the tray may be formed from a flexible plastic or wax paper that has been sprayed with a non-stick coating. In these embodiments several finished pizza sheets with trays may be stacked on one another, with a rigid tray at the very bottom. An exemplary embodiment a stacked formation of pizza sheets 180 is demonstrated in FIG. 5. As shown, twelve pizza sheets 185 separated by wax paper 190 are in a stacked formation and supported from the bottom by a rigid tray 195. In this embodiment the entire stacked formation may be packaged together.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A method of preparing a frozen pizza sheet, comprising:
obtaining a transport tray;
applying a predetermined amount of cheese to the top surface of said transport tray;
applying a predetermined amount of one or more toppings to said cheese;
heating said transport tray and contents until said cheese achieves at least partial melt; and
cooling said transport tray and contents to a predetermined temperature.

2. The method of claim 1, further comprising the step of packaging said transport tray.

3. The method of claim 1, further comprising the step of removing said cheese and said toppings from said transport tray and placing a wax sheet between said transport tray and said toppings.

4. The method of claim 1, wherein said transport tray is circular.

5. A method of preparing pizzas, comprising:
obtaining a pizza sheet, wherein said pizza sheet is a composite comprising cheese and at least one topping.
placing said pizza sheet on prepared pizza dough
baking said pizza sheet and said pizza dough.

6. The method of claim 5, wherein said pizza sheet is frozen.

7. The method of claim 5, wherein said pizza sheet is refrigerated.

8. The method of claim 5, wherein said prepared pizza dough includes pizza sauce.

9. The method of claim 5, wherein said pizza sheet composite further comprises one or more spices.
